(19) United States
(12) Patent Application Publication
(10) Pub. No.: US 2002/0198806 A1
(43) Pub. Date: Dec. 26, 2002

(54) Systems and methods for accessing and modifying usage parameters associated with a financial transaction account

(75) Inventors: Lynn H. Blagg, Omaha, NE (US); Eugene F. Kathol, Omaha, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO

(21) Appl. No.: 10/172,378

(22) Filed: Jun. 13, 2002

Related U.S. Application Data
(63) Continuation-in-part of application No. 09/298,417, filed on Apr. 23, 1999.
(63) Continuation-in-part of application No. 09/298,505, filed on Apr. 23, 1999.
(63) Continuation-in-part of application No. 09/298,521, filed on Apr. 23, 1999.
(60) Provisional application No. 60/083,004, filed on Apr. 24, 1998.

(51) Int. Cl. G06F 17/60

(52) U.S. Cl. 705/35

(57) ABSTRACT

Systems and methods for providing access to usage parameters associated with financial transaction accounts. Such can include providing an account and one or more usage parameters associated therewith. Further, a request to modify one or more of the usage parameters is received, and the modification is implemented.

### CROSS-REFERENCES TO RELATED APPLICATIONS

This U.S. patent application is a continuation-in-part of the following U.S. patent application Ser. Nos.: 09/298,417 filed Apr. 23, 1999, entitled “Methods for Processing a group of Accounts Corresponding to Different Products”, and assigned to the assignee of the present invention; 09/298,505 filed Apr. 23, 1999, entitled “Method for Linking Accounts Corresponding to Different Products Together to Create a Group”, and assigned to the assignee of the present invention; and 09/298,521 filed Apr. 23, 1999, entitled “Method for Defining a Relationship Between an Account an a Group”, and assigned to the assignee of the present invention. The entirety of all of the aforementioned patent applications, as well as the corresponding PCT applications (PCT/US99/31315, PCT/US99/31202, PCT/US99/31203), are incorporated herein by reference for all purposes.

### BACKGROUND OF THE INVENTION

The present invention relates generally to the field of financial products, and more particularly to systems and methods for accessing and controlling use of one, or a group of financial products.

Financial transaction card products, i.e. credit and debit cards, are very popular for conducting a wide range of consumer and business transactions involving payments for various goods and services. They offer significant advantages over other payment methods, such as cash and checks. These advantages include convenience, security and acceptability to providers of goods and services. Another advantage is that such transactional cards can be used remotely, i.e. by telephone or by global computer network (“Internet”), as well as at points-of-sale.

Multiple account/product relationships with a single issuer are common. They can accommodate the needs of individual account holders that use different products for different purposes. A typical example involves business and personal accounts with a single issuer. With this arrangement the account holder can separate business and personal purchases for record keeping and tax reporting purposes. Card issuers tend to foster relationships with their preferred customers by encouraging them to open additional accounts.

The proliferation of products from respective card issuers has provided consumers with a wide range of choices and considerable flexibility in managing their credit/debit finances, both personal and business-related. The card issuers, such as banks and other financial institutions, typically promote the use of their respective products through various incentive programs involving features of their products. These features can include increased spending limits, favorable interest rates and “reward points” for product usage. In general, the functionality of such products has increased in scope and complexity as issuers offer more choices and flexibility.

The variety of product offerings has created a great number of opportunities to market such products, however, in some cases, the flexibility and complexity of the offered products has resulted in greater costs related to servicing the various products. Accordingly, it is desirable to facilitate a variety of products, while reducing costs associated with providing a broad product offering. Hence, the present invention addresses this and other needs.

### BRIEF SUMMARY OF THE INVENTION

The present invention provides systems and methods for providing access to usage parameters associated with financial transaction accounts. Such can include providing an account and one or more usage parameters associated therewith. Further, a request to modify one or more of the usage parameters is received, and the modification is implemented. In some embodiments of the present invention, changes to the usage parameters can be requested via one or more communication networks, and the changes can be implemented without interaction with an employee of the issuer. Among other things, this provides advantages in flexibility and privacy to an account holder, and cost savings to an issuer. Further, in some embodiments, limits upon any changes allowed by an account holder are predefined. Thus, a request by an account holder does not need to await authorization by an issuer. Yet further, in some embodiments, a request to modify usage parameters can be subject to rules imposed by one or more members of a group to which the usage parameter relates. Thus, among a variety of options supported by the present invention, rules can be defined by members of a group, and those rules used to control any requested usage parameter modifications. Such an approach limits the control of an account by an issuer, and by an account holder.

One particular embodiment of the present invention provides a method for accessing usage parameters associated with a financial transaction account. The method includes providing an account group where the account group includes a dependent account that is associated with at least one usage parameter. The method further includes receiving a request to modify the usage parameter, and modifying the usage parameter.

In some aspects of the embodiment, the account group further includes a key account, and the method further includes authorizing an account holder that is identified as the key account holder. The aspect can further include presenting an additional usage parameter to the key account holder, and receiving a request to modify the usage parameter that indicates the additional usage parameter.

In other aspects of the embodiment include authorizing an account holder associated with the account group where the account holder is identified as the dependent account holder, and presenting another usage parameter to the dependent account holder. The request to modify the parameter includes an indication of the second usage parameter. This aspect b can further include analyzing a dependent strategy associated with the dependent account such that presenting the other usage parameter is based at least in part on the analysis of the dependent strategy, and/or analyzing the dependent strategy to determine if the other usage parameter is allowable.

Yet other aspects include a key account within the account group and the method further includes authorizing an account holder associated with the account group, wherein the account holder is identified as the dependent account holder. In addition another usage parameter is presented to the dependent account holder, wherein the request to modify the usage parameter includes an indication of the other usage parameter. In addition, authority to implement the request to modify the usage parameter is requested from the key account holder. In various aspects, the usage parameter can be a parameter related to liability for the dependent account, a parameter related to a credit limit of the dependent account, a parameter related to notification of activity associated with the dependent account, a parameter related to linking the dependent account to the account group, and/or a parameter related to security associated with the dependent account.

Other embodiments of the present invention provide a method for modifying usage parameters associated with financial accounts. Such methods include providing a dependent strategy from an issuer, wherein the dependent strategy includes a usage parameter that at least in part defines an account. Additionally, the methods include receiving a request to modify the usage parameter from an account holder, and modifying the usage parameter. In some aspects, the request to modify the usage parameter is received via an automatic voice response system, or the Internet. Yet other aspects include associating the account with a group of accounts.

Yet other embodiments of the present invention provide a method for modifying usage parameters associated with financial accounts. Such methods include issuing a credit card to an account holder where at least a first usage parameter is associated with the credit card. The first usage parameter can be a parameter related to liability for the credit card, a parameter related to a credit limit of the credit card, a parameter related to notification of activity associated with the credit card, a parameter related to linking the credit card to the group of accounts, and/or a parameter related to security associated with the credit card. A second usage parameter is presented to an account holder via the Internet, and a request to modify the first usage to the second usage parameter is received, and the first usage parameter is modified.

These and other aspects are more fully developed in the detailed description below. Thus, the summary provides only a general outline of the embodiments according to the present invention. Many other objects, features and advantages of the present invention will become more fully apparent from the following detailed description, the appended claims and the accompanying drawings.

### BRIEF DESCRIPTION OF THE DRAWINGS

A further understanding of the nature and advantages of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components and/or a group of similar components.

FIG. 1 is a block diagram illustrating an exemplary relationship between a card processing and service provider, issuers and cardholders;

FIG. 2 is a block diagram illustrating an exemplary relationship between a card processing and service provider, an issuer and the cardholders within a group;

FIG. 3 is a block diagram illustrating another relationship between a card processing and service provider, issuers and the cardholders within a group;

FIG. 4A is a block diagram illustrating the files included in the group master data;

FIG. 4B is a block diagram illustrating group master data;

FIG. 5 is a block diagram illustrating several factors which can be pre-designated as limits for credit card use;

FIG. 6 is a block diagram illustrating a relationship between a card processing and service provider, an issuer and a special card according to the present invention;

FIGS. 7A and 7B are block diagrams illustrating exemplary relationships between a card processing and service provider, issuer and the pre-defined card held by one member of the group;

FIGS. 8A and 8B are block diagrams illustrating exemplary relationships between a card processing and service provider, an issuer, a cardholder and a pre-designated credit card according to the present invention;

FIG. 9 is a block diagram illustrating the relationship between group master data and data associated with a pre-defined card;

FIG. 10 is a flow diagram illustrating steps for adding a dependent account to a group;

FIG. 11 is a block diagram of some of the major components in a system for practicing the financial transaction account methodology of the present invention;

FIG. 12 is a flow diagram showing an account holder interface with a financial transaction account pursuant to the methodology of the present invention; and

FIG. 13 is a block diagram of a system showing alternative points of entry whereby an account holder can access a financial transaction account according to the methodology of the present invention.

### DETAILED DESCRIPTION OF THE INVENTION

Various embodiments of the present invention provide systems and methods for facilitating flexible and efficient maintenance of financial products. For example, in one embodiment of the present invention, a user can modify security thresholds associated with one or more credit card products. Thus, a user can request activation of a security trigger whenever a credit card is used outside of a geographic area, and change that trigger to indicate a different geographic location for a period when the user will be on vacation. In some embodiments, such a change can be effectuated by a user without interacting with an employee of the card issuer. This and many other applications of the present invention are described herein.

Further, some embodiments of the present invention provide flexibility in creating and/or modifying usage parameters associated with an account and/or product. As used herein, a usage parameter can be any parameter governing access to and control of an account or product. Thus, for example, usage parameters associated with an account or product can include, but are not limited to, parameters related to liability for an account, parameters related credit limits of an account, parameters related to notification of activity associated with an account, parameters related to linking an account to a group of accounts, parameters related to security associated with an dependent account, and the like. Additionally, usage parameters can define security requirements, access limits, other group affiliations, and the like. Further, one or more usage parameters can be combined to form a dependent strategy. In some embodiments of the present invention, such dependent strategies are provided to define relationships between one or more accounts and/or products associated in a group. Thus, as one particular example, a dependent strategy may include usage parameters that allow spending on a dependent account up to ten percent of a credit limit of another account included in the same group of accounts. Further, the dependent strategy can limit the types of goods that can be purchased using the dependent account, and rights that the account holder associated with the dependent account maintains. Such rights can indicate that the account holder is not liable for the balance of the dependent account, but does receive a statement detailing the balance. Additionally, the dependent strategy can include usage parameters that control whether the account holder is free to modify the dependent strategy. Further, where the account holder is free to modify the dependent strategy, such modifications can require authorization by a superior account holder within the group before the modifications are implemented. Based on the disclosure provided herein, one of ordinary skill in the art will recognize a myriad of usage parameters and/or dependent strategies that are possible in accordance with the present invention.

Further, as used herein, an account holder can be any individual or entity associated with an account or product. Thus, for example, an account holder can be a credit card holder, a debit card holder, a holder of a bank account or stored value account, or the like.

Flexibility in relation to usage parameters can be controlled by an account holder, or an individual or entity associated with the account holder via a group relationship. For example, an account holder may procure a first product for personal use, another product for use by dependents of the account holder, a third product for business use, and the like. The account holder may desire different usage parameters for each of the respective products, which often share unique and dynamic relationships. As such multiple account/product relationships can vary over time, the account holders may find it advantageous to modify the various usage parameters associated with the accounts and/or products to accommodate changing needs serviced in relation to the account/product, and to manage the use of such accounts and/or products. To facilitate such an ability, the present invention provides various methods permitting access and control of usage parameters.

Many credit/debit card account holders encounter personal and/or business circumstances which necessitate changing usage parameters associated with one or more products and/or accounts. For example, account holders may procure multiple cards associated with individual credit/debit products. The additional cards are often distributed to family members for personal use, employees (where the account holder is a business) for business use, and the like. Account holders can establish certain usage parameters for the additional cards on their credit/debit products. Over time, changing business and personal circumstances may alter the preferred usage parameters. Various embodiments of the present invention provide an account holder with the ability to access and control various usage parameters. Further, some embodiments of the present invention provide methods for controlling usage parameter access differently among the different accounts and products, where such accounts and products can be offered and/or services from one or more issuers, agents and/or principles. Moreover, some embodiments of the present invention permit continuous, interactive access and control of usage parameters by account holders and/or members of a group associated with the account holders. Such functions can be particularly applicable to applications which are related to accounts and/or products linked as a group. The functions are also applicable to applications which do not involve group relationships. Thus, both single and multiple account applications can benefit from the methods of the present invention.

Control over the increasingly flexible product usage parameters has generally remained in the hands of the product issuers. Changing usage parameters on existing accounts/products tends to be relatively labor-intensive and hence costly using current methodologies. Thus, for cost-control purposes, the issuers may retain control over the usage parameters for their respective products. Under current financial transaction product models, relatively little usage parameter flexibility is available to the account holders. For example, account holders are typically limited to contacting product issuers through limited points-of-access in order to affect desired changes. Further, modifying usage parameters generally involve interactions with one or more employees of the product issuer. The account holder provides their instructions to the employee(s), and the employee(s) effectuate or deny the request. In addition to the costs incurred through interaction with the employee(s), additional costs may be incurred by the product issuers for recording, confirming and implementing such modifications. Since product usage parameters may require modification any number of times during the life of a particular account, the costs associated with providing such services can be significant and recurring.

In part to address the aforementioned cost burdens, some embodiments of the present invention provide direct access for modifying usage parameters to an account holder. As such, these embodiments of the present invention allow product issuers to provide account customers with a degree of control, while controlling costs.

From the standpoint of the account holder, usage parameter management can involve finding the appropriate balance between risk and convenience. For example, credit card fraud is so pervasive that product issuers must devote considerable resources to detecting and preventing fraudulent transactions. Fraud-control procedures include monitoring usage patterns such that unusual activity can be promptly detected. Usage patterns that are observed for fraud detection include the geographical locations in which purchases are attempted and the types of purchases. These factors can provide early indications of a stolen card or the unauthorized use of an account number.

Credit card fraud can be controlled somewhat by closing and opening accounts. For example, some credit card issuers advise their customers to close their accounts after attending major international sporting events, such as the Wimbledon Tennis Tournament, because the risk of fraudulent activity is high. Although effective, closing and reopening credit card accounts tends to be relatively expensive and thus not a particularly desirable solution.

Some embodiments of the present invention provide an account holder with an ability to modify usage parameters to obtain a similar effect as that obtained by opening and closing an account as discussed above. Account holders can thereby determine their thresholds of risk versus convenience in setting such parameters. For example, placing fewer usage restrictions on products generally makes their usage more convenient. However, the thresholds for detecting fraudulent activity are correspondingly lower. The present invention enables account holders to modify such usage parameters relatively quickly and efficiently through a wide range of access points. For example, a financial transaction product holder might vary the geographic usage parameters for credit cards in advance of upcoming travel. Significant card usage in locations which are away from home for the account holder might therefore be permissible. Upon concluding the travel, the account holder can reset the usage parameters to their previous conditions whereby remote usage would activate fraud control procedures.

Moreover, various systems and methods in accordance with the present invention enable modification of usage parameters to be effected globally for multiple cards under individual products, and for the accounts individually in a multiple account relationship. An account holder can thereby adjust the operating usage parameters to account for the activities of, for example, their dependents as they travel. Further, in some embodiments, such modifications to usage parameters can be received and implemented in real time.

From the standpoint of the account holders, greater access, control and management facilitates tailoring the usage parameters associated with credit/debit products to changing personal and business circumstances, objectives and functions. Such user-based control can provide multiple points of access, some of which are not limited to usage within normal business hours. Moreover, such access can occur in real time whereby usage parameter modifications can be implemented almost instantaneously. Account holders are thus is empowered to adapt their credit/debit products in rapid response to their needs and applications for same, as well as the needs and applications for the additional cardholders associated with particular credit/debit products. The products are thus tied to and highly responsive to relationship management imposed by the account holders, for example, among the multiple cardholders associated with their respective accounts. Usage parameters can be highly customized by the account holders to accommodate the relationships with and among their respective cardholders.

Some embodiments of the present invention provide for protecting the privacy of an account holder. More particularly, modifications to various usage parameters are implemented anonymously, without interacting with an employee of a product issuer. Such anonymity can reduce an account holder's privacy concerns. Further, various privacy and security features can be implemented to protect the account holders and cardholders.

As an example, circumstances giving rise to product usage modifications by account holders include the maturing of individual cardholders with corresponding greater financial needs and responsibilities. Another example includes budget changes in both personal and business contexts, for example in response to anticipated changes in usage. Such ability to modify usage parameters provides dynamic control of known account holder needs and avoids the problems with product usage controls which are either too restrictive or too permissive.

From the standpoint of product issuers, shifting dynamic control of product usage to account holders has the effect of enhancing product value. Enhanced product value has a number of benefits, including greater consumer loyalty and more extensive use of the products of a particular provider. Moreover, card issuers can reduce their fraud exposure and liability to account holders by shifting access, control and management of usage parameters to the account holders, who are generally in the best position to be aware of and respond to their unique and dynamic circumstances.

Credit/debit products can be subject to various rules regarding their usage. Such rules can be established by the card processing and service providers and the product issuers. Other rules and regulations are established by statute and regulation, including statutes, rules and regulations pertaining to financial institutions, credit and lending practices and credit reporting. The methodology of the present invention enables account holders to access, control and manage their usage parameters, all subject to compliance with such laws, rules and regulations. Account holders can be presented with various options under the methodology of the present invention. Once requested, such product usage parameter modifications can again be tested against predefined limits and/or rules.

The detailed description which follows is represented largely in terms of processes and symbolic representations of operations by a conventional computer. The processes and operations performed by the computer, in both a stand-alone environment and a distributed computing environment, include the manipulation of signals by a processor and the maintenance of these signals within a data set, such as a database and a data structure. Each of these data sets and data structures are resident in one or more memory storage devices. Basically, a data set is a collection of related information in separate elements that are manipulated as a unit. A data structure is a structured organizational scheme that encapsulates data in order to support data interpretation and data operations. The data structure imposes a physical organization upon the collection of data stored within a memory storage device and represents specific electrical or magnetic elements.

For purposes of this disclosure, a method or process is generally conceived to be a sequence and/or a group of manual and/or computer-executed steps leading to a desired result. In addition, it should be understood that the methods and systems described herein are not related or limited to any particular computer (stand-alone or distributed) or apparatus. Furthermore, the methods and systems are not related or limited to any particular communication architecture. Thus, based on the disclosure provided herein, one skilled in the art will be able to implement the systems and methods of the present invention with general purpose machines or specially customized programmable devices according to the teachings of this disclosure.

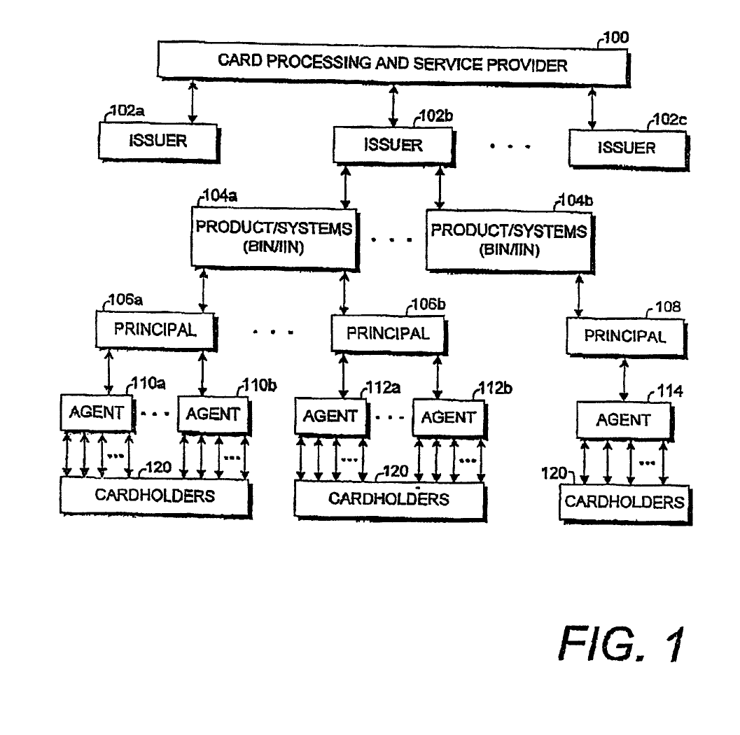

The processing of a transaction including, for example, a credit card transaction, can involve a account holder, a merchant, a merchant acquirer, the card issuer, and a card processing and/or a service provider. FIG. 1 illustrates an exemplary relationship between a card processing and service provider 100, a number of issuers 102a, 102b . . . 102c, and a number of account holders 120. Card processing and service provider 100 supports issuers 102a, 102b . . . 102c by authorizing and processing transactions, as well as providing support for creating new accounts, modifying accounts, controlling communications to account holders 120 and/or implementing and facilitating reward programs. An issuer, such as issuer 102b, is typically a bank or other financial institution that issues one or more products including, but not limited to, credit card products. Issuer 102 manages transaction processing at the account level. In some case, issuer 102 manages a number of accounts using a hierarchy, such as a product/system 104, principal 106, 108, and agent 110, 112, 114 hierarchy shown in FIG. 1. Account holders 120 can be individuals holding a general purpose credit card or general purpose charge card, such as a VISA, MASTERCARD, or private label card. In addition to the elements shown in FIG. 1, additional elements (not shown) may also be included. For example, additional issuers 102, product/system 104, principals 106, 108, and/or agents 110, 112, 114 may exist.

Issuer 102 can issue different types and versions of credit card products. For example, issuer 102 may offer a VISA product and a MASTERCARD product. Each product can be offered in standard, gold and platinum versions. Product/system 104 can correspond to different products. Thus, for example, where issuer 102b issues a VISA product and a MASTERCARD product, product/system 104a may correspond to the MASTERCARD product and Product/System 104b to the VISA product. Each product typically includes a either a BIN (Bank Identification Number) or an IIN (Issuer Identification Number) that is used by issuer 102 to direct processing to an associated Product/System 104.

Issuers 102 can use additional levels of reporting structures below the level indicated as product/system 104 to manage large portfolios. As illustrated, FIG. 1 shows a principal 106, 108 level and an agent 110, 112, 114 level. In some cases, the divisions between principal 106, 108 level and agent 110, 112, 114 level are defined by issuer 102. Some issuers 102 use principals 106, 108 and agents 110, 112, 114 to make geographic divisions. Thus for example, principal 106a could correspond to a geographic region, such as the southeast, and agent 110a could correspond to a state within such region. Where such an agent 110, 112, 114 and principal 106, 108 structure is employed, one or more account holders 120 are associated with the various agents 110, 112, 114. Thus, for example, a number of account holders 120 can be associated with a single agent 114. As will be apparent to those skilled in the art based on the teaching of this disclosure, alternative hierarchies are also possible.

An individual or entity can hold a number of different cards corresponding to a number of different accounts. Thus, the same account holder 120 may be associated with two accounts, where one account is processed by issuer 102a and the second account is processed by issuer 102b via agent 110b, principal 106a, and product/system 104a. Alternatively, account holder 120 may be associated with two or more accounts processed via the same issuer 102, where the processing for each account is handled independently via different agents 110, 112, 114, principals 106, 108, and/or product/systems 104.

Further, a group 150 of individuals or family of individuals may include account holders 120 that each may hold several cards. Account holders 120 within the group may be related either as a family or via a contractual relationship, and the payments may be made from group funds. However, in such cases, each of the accounts is still processed independently. For example, Table 1 illustrates the credit cards held by an exemplary group that happens to be a family.

TABLE 1

| | STANDARD | STANDARD | GOLD | PRIVATE |
|---|---|---|---|---|
| Cardholder | VISA | MC | MC | LABEL |
| MOTHER | Account 1 | | Account 2 | |
| FATHER | | | Account 3 | Account 4 |
| SON | Account 5 | | | |
| DAUGHTER | | Account 6 | | Account 7 |
| GRAND- | | Account 8 | | |
| FATHER | | | | |

Each of the accounts shown in Table 1 is an independent account from the perspective of issuer 102. Said another way, the standard MASTERCARD account associated with the daughter (Account 6) is independent of the standard MASTERCARD account associated with the grandfather (Account 8) and the gold MASTERCARD account associated with the mother (Account 2) is independent of the gold MASTERCARD account associated with the father (Account 3). The processing options used by issuer 102 to process the accounts shown in Table 1 can differ by product.

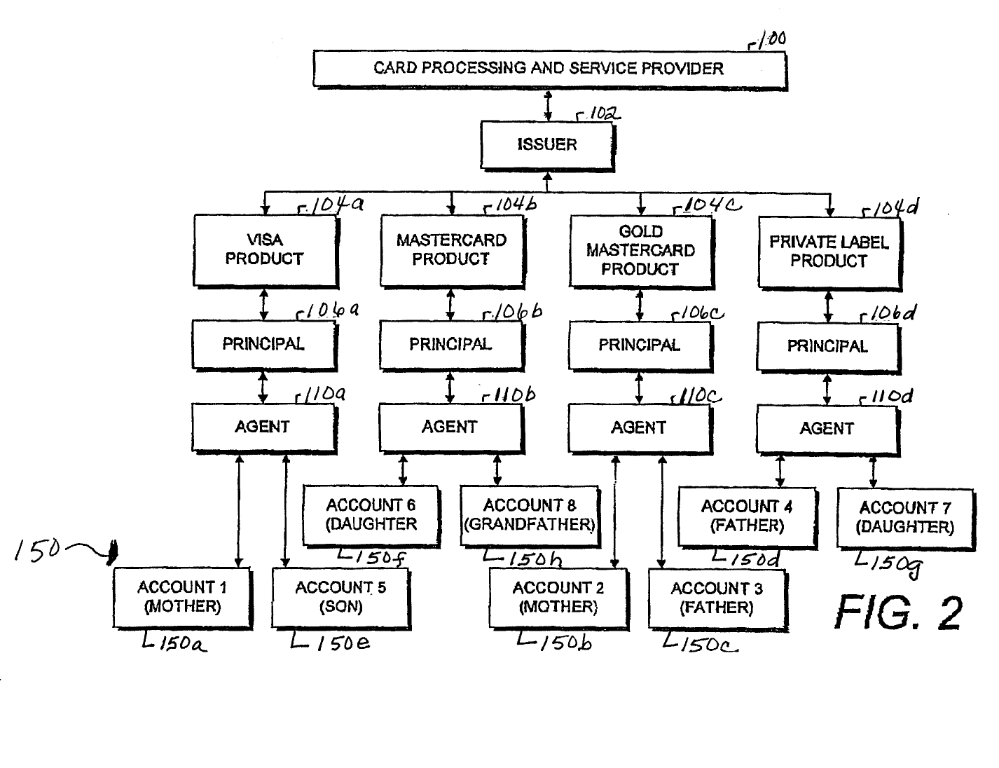

The relationships between the different accounts shown in Table 1, issuer 102, and card processing and service provider 100 are illustrated in FIG. 2. Card processing and service provider 100 supports issuer 102. Issuer 102 issues a variety of credit card products, including a standard VISA product 104a, a standard MASTERCARD product 104b, a gold MASTERCARD product 104c, and a private label product 104d. A group 150 of accounts is also illustrated. Account 1 (element 150a) and account 5 (element 150e) are shown under standard VISA product 104a, Account 6 (element 150f) and account 8 (element 150h) are shown under standard MASTERCARD product 104b, account 2 (element 150b) and account 3 (element 150c) are shown under gold MASTERCARD product 104c, and account 4 (element 150d) and account 7 (element 150g) are shown under the private label product 104d.

The accounts shown in Table 1 and FIG. 2 can be linked together to create group 150. A group can include any number of accounts that correspond to a common issuer 102. In various embodiments of the present invention, accounts linked as a group can be processed as a group for various purposes, while maintaining independent processing of each of the individual accounts. In some embodiments, each group 150 includes a primary owner. In such cases, the primary owner can correspond to a account holder 120 associated with a key account within the group. Thus, for example, the standard VISA account held by the mother (element 150a) can be designated as the key account for the group shown in Table 1 and FIG. 2. The remaining accounts in the group are referred to as dependent accounts. The relationship between an account and the group is independent of the relationship between the remaining dependent accounts and the group. In some cases, issuer 102 defines the possible relationships between a dependent account and group 150.

FIG. 2 shows one possible organization for a group, and it should be recognized that other organizations are also possible. As shown in FIG. 2, the accounts in group 150 can be associated with different products 104. There are no restrictions on the placement of the accounts in a group at product/system 104, principal 106, and/or agent 110 levels. The accounts in group 150 can be split between different product/Systems 104, principals 106, and agents 110. In some cases, the key account and a dependent account can be associated with a common agent 110. Multiple dependent accounts can also be associated with a common agent 110. Further, the accounts associated with an agent 110 are not required to be in the same group (or any group at all).

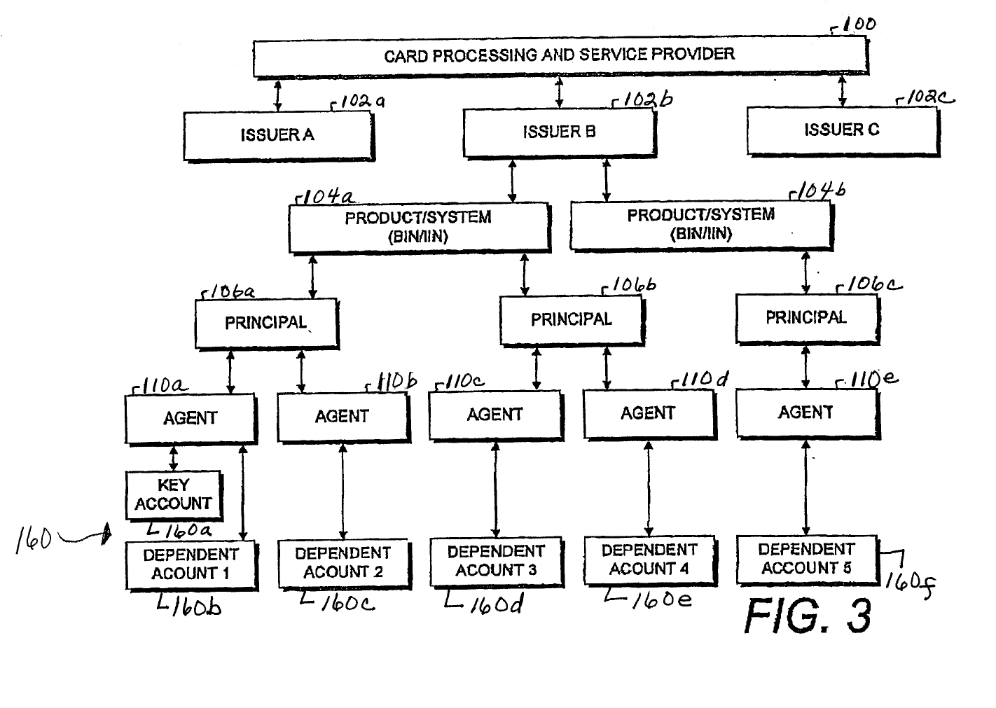

FIG. 3 shows an exemplary group 160 where a key account 160a and a dependent account 1 (element 160b) are associated with the same Agent 110a. Dependent account 2 (element 160c) is associated with a different Agent 110b, but is the same type of product 104a as key account 160a and dependent account 1 (element 160b). Dependent account 3 (element 160d) is associated with a different Principal 106b than key account 160a. Further, dependent account 1 (element 160b), and dependent account 2 (element 160c) are associated with a different agent 110d than dependent account 3 (element 160d). However, accounts 160b-160c are associated with the same principal 106b. Dependent account 5 (element 160f) is a different product 104b than any of the other accounts 160a-160e in group 160. Although FIG. 3 only shows a single group 160, additional groups or individual accounts can exist under issuer 102b. Furthermore, additional groups can exist under the other issuers 102a, 102c.

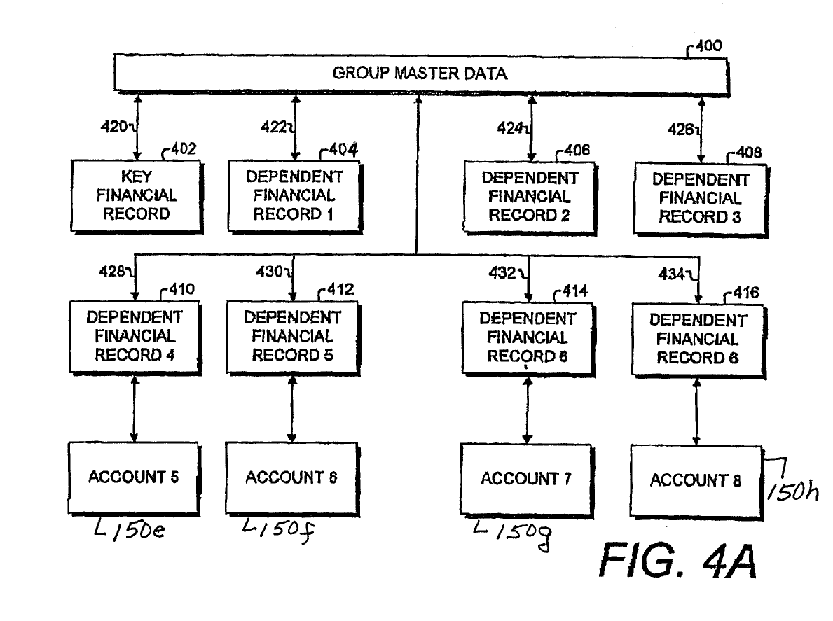

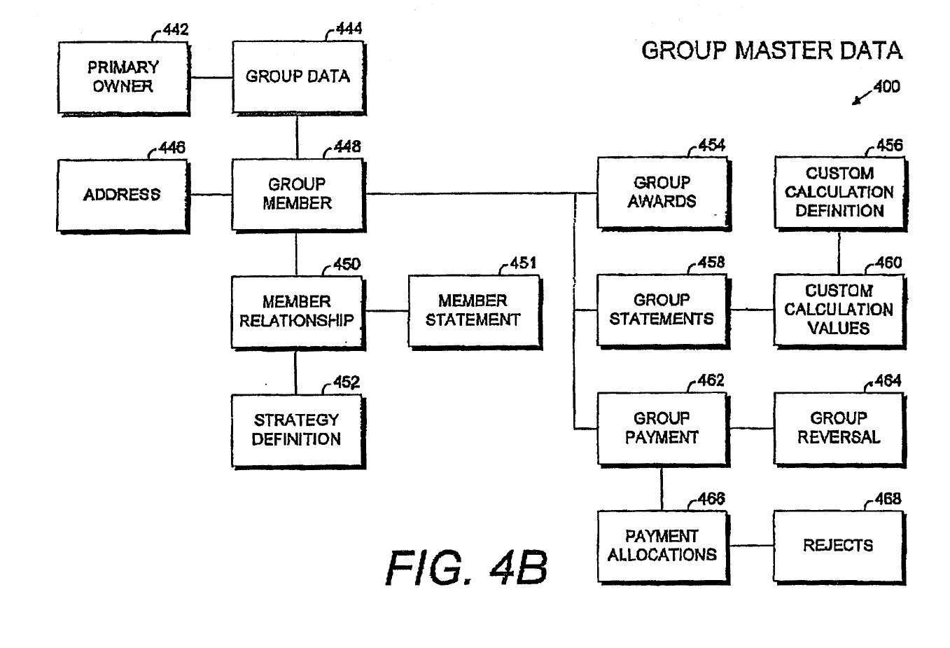

Linking accounts 160a-160f into a group 160, or accounts 150a-150h into a group 150 is accomplished by linking a financial record that corresponds to each account to a group master data 400 as illustrated in FIG. 4A. More particularly, FIG. 4A illustrates the linking of accounts 150a-150h via group master data 400. Group master data 400 includes information about group 150 including, but not limited to, group control settings, group aggregate data, and a group identifier. Group master data 400 is discussed in more detail below in connection with FIG. 4B. A key financial record 402 corresponds to the key or primary owner of group 150. Key financial record 402 can also correspond to a key account held by the primary owner of group 150. In this example, key financial record 402 corresponds to the standard VISA account held by the mother, account 1 (element 150a). A relationship 420 between key financial record 402 and group master data 400 is a predefined relationship (i.e., a relationship defined by issuer 102).

In addition to key financial record 402, group 150 also includes dependent financial records 404, 406, 408, 410, 412, 414 and 416 that correspond to dependent accounts 150b-150h. Thus, for example, account 2 (element 150b) is associated with dependent financial record 404. Each account is also associated with one or more cardholders, e.g., the mother is the cardholder associated with account 2 (element 150b).

Dependent accounts 150b-150h in group 150 can cross product lines. In this example, account 2 (element 150b) and account 3 (element 150c) are MASTERCARD products, account 4 (element 150d) and Account 7 (element 150g) are private label products, account 5 (element 150e) is a VISA product, and Account 6 (element 150f) and Account 8 (element 150h) are MASTERCARD products. A relationship 422 between dependent financial record 404 and group master data 400 is independent of the relationship between the remaining dependent financial records 406, 408, 410, 412, 414 and 416 and group master data 400.

The dependent accounts 150b-150h can also have different types of ownership. For example, the primary owner and a dependent cardholder can be jointly responsible for a dependent account, the primary owner can be responsible for a dependent account where a dependent cardholder is an authorized user, or a dependent cardholder can be solely responsible for a dependent account. In addition, a dependent cardholder can be jointly liable with the primary owner for the group liability. If a dependent cardholder is jointly liable with the primary owner for the group, then the dependent account is a jointly liable dependent account.

Group master data 400 is further illustrated in FIG. 4B, which illustrates a number of files 442-468. Each of the files includes records that contain information about group 150 and accounts 150a-150h that are associated with group 150. A group data file 444 includes information about group 150, such as a group identifier, a group cycle code, a group credit line, and a group collector code. The group identifier identifies group 150. Each of the records associated with the group includes the group identifier. It is noted that FIG. 4B shows several dependent accounts. Any one of these dependent accounts can be the account associated with a pre-designated credit card, and the discussion that follows will be applicable to such a credit card.

The group cycle code indicates the cycle code for group 150. In some cases, where group 150 includes a key account, then the cycle code for the key account is used as the group cycle code. In other cases, where group 150 does not include a key account, then the group cycle code can be a default cycle code or can be based upon the cycle code of one of the dependent accounts in group 150. The group credit line specifies the credit available for the accounts in the group that authorize against the group credit line. The group collector code may be set once a collector is assigned to one of the accounts in the group. A collector may be assigned because the account is delinquent. If another account in the group becomes delinquent, then the group collector code is checked and the same collector can be assigned to that account if a group collection option is used.

A primary owner file 442 includes information about the primary owner of group 150. The primary owner is the individual that is liable for the group. In some instances, where more than one individual is liable for group 150, then those individuals can be jointly liable for group 150. Information about such individuals is stored in primary owner file 442. For example, a primary owner and a dependent cardholder can be jointly liable for group 150. For simplicity, the term “primary owner” is used herein to include a single primary owner or joint primary owners. In one embodiment, every group has a primary owner. Further, in some cases, group 150 includes a key account, and the primary owner is the holder of the key account.

A group member file 448 includes a record for each of the accounts that is (or was) a member of group 150. Each record includes, among other things, an account number, an indication as to whether the account is a key account or a dependent account, and group membership information. In some case, a record is maintained for an account in group member file 448 even if the account is delinked from the group. Each record includes group membership information which indicates when the account was linked to group 150 and if the account is no longer a member of group 150 (e.g., when the account was delinked from group 150). An address file 446 includes a record for each of the accounts that is (or was) a member of group 150. Each record includes the mailing address of the cardholder associated with the account.

A member relationship file 450 includes a record for each of the accounts that is (or was) a member of group 150. A member relationship record contains information about the dependent strategy associated with an account. In some cases, where the dependent strategy associated with the account has changed, member relationship record 450 contains information about the previous dependent strategy or strategies, as well as the current dependent strategy. Further, member relationship record 450 can also contain information about the effective dates of each dependent strategy.

A dependent strategy definition file 452 includes a record for each of the defined strategies. The dependent strategy definition records include the usage parameters that define the dependent strategies referred to in member relationship record 450, including any usage parameters and limits that might be associated with a pre-defined credit card. In some embodiments, where the definition of a dependent strategy has changed, then the dependent strategy definition record for that dependent strategy also includes the usage parameters that defined the previous version or versions of the dependent strategy, as well as the effective dates of each dependent strategy definition. Information about previous dependent strategies can be used in relation to pre-defined cards.

A member statement file 451 includes records for each account that is (or was) a member of group 150. Each record includes a number of fields that store statement data (monetary information) for the associated account. In addition, each record includes a flag that indicates whether the associated account cycles with the group (i.e., has the same cycle code as the group) or cycles independently. The information stored in member statement file 451 is used to generate a group statement, dependent statement, and/or a courtesy statement. Dependent and courtesy statements are particularly helpful for a pre-defined card.

A group statement file 458 includes records that contain group monetary and group non-monetary information. The group monetary information includes the group balances, as well as the group credit line and group available credit for a particular statement. The group non-monetary information includes the group payment due date, as well as any parameters associated with pre-defined cards that are non-monetary in nature. Typically, the group payment due date is the earliest due date of all the accounts in the group that are paid by the primary owner. The information stored in group statement file 458 is used to generate the group statement. Further, information in member statement file 451 and group statement file 458 can be used to determine the initial break up of a group payment. The information can also be used to support the on-line display of statement information to an operator.

A group rewards file 454 includes a record for each of the reward programs for group 150. Each record includes information about the reward program, such as reward program identifier and the amount of group points accumulated in that reward program.

A custom calculation definition file 456 and a custom calculation values file 460 support customized group calculations that appear in a field on the group statement. Each custom calculation definition file 456 includes a formula for a customized group calculation. In some cases, a formula specifies that a customized group calculation is calculated using monetary elements from the accounts in group 150, including a pre-defined card account. The value that is calculated using the formula is stored in a custom calculation values record.

A group payment file 462 includes a record for each group payment received. Each record includes the amount of the group payment and the date the group payments was received. A payment allocations file 466 includes a record for each group payment received. Each record indicates how the group payment was allocated among the accounts in group 150. A group reversal file 464 includes a record for each group payment that has been reversed. If a group payment is reversed, then the reversal is made by referencing payment allocation file 466 to determine how the payment was originally allocated. A rejects file 468 includes records of rejections detected during the processing other than group processing. A record in rejects file 468 includes a rejection report that provides details of the rejection. The files shown in FIG. 4B illustrate exemplary types of files comprised in a group master data file 400. As will be apparent to those skilled in the art, group master data 400 can be stored using alternative types of files and records.

In some embodiments, the relationship shown in FIG. 4A between the dependent financial records 422, 424, 426, 428, 430, 432, 434 and group master data 400 is defined by a set of parameters. The parameters can be provided by the card processing and service provider 100. A set of usage parameters can be selected to create a customized dependent strategy. As will occur to those skilled in the art based on the teaching of this disclosure, a dependent strategy can include the parameters and/or limits associated with a pre-defined card, and the disclosure of the dependent strategies herein can be applied to such a pre-defined card. Either card processing and service provider 100 or issuer 102 can select the usage parameters to create a dependent strategy. In some cases, card processing and service provider 100 provides parameters and issuer 102 selects a set of usage parameters that is suitable for a particular situation. Alternatively, card processing and service provider 100 could provide dependent strategies or group of usage parameters, rather than just individual usage parameters. If card processing and service provider 100 provides dependent strategies, then each of issuers 102 supported by card processing and service provider 100 can choose among the provided dependent strategies. However, if card processing and service provider 100 provides parameters, then each issuer 102 can customize the dependent strategies offered to its customers, as will be the case with a pre-defined card. In some embodiments the dependent strategies are labeled. For example, a dependent strategy for a college-age child residing at school may have one label, whereas a dependent strategy for a second account for the primary owner may have another label. This applies to a pre-defined card as well.

A dependent strategy specifies the relationship between a dependent account and group 150 by specifying various group and/or account processing options for the particular account. The group processing options provide flexibility in the relationships between the dependent accounts and group 150, and provide for automatic processing at the group level. In some cases, the dependent strategy includes usage parameters that define how transactions are authorized for the dependent account, as well as whether payment for the account is due from the primary owner or from the dependent account cardholder. In addition the dependent strategy includes, among other things, options for payment application, statement generation, cardholder communications, and reward pooling.

Thus, for example, the usage parameters can be selected to create a dependent strategy appropriate for a dependent, college-age child that resides at school. Such parameters are particularly useful if the credit card is pre-defined to apply to certain purchases made at that school, such as books, restaurants in the immediate vicinity of the campus, any campus store, time limits associated with the school term, or the like. The usage parameters can be selected so that the child is liable for the account and the parent receives information about the activity of the account. Alternatively, the usage parameters can be selected so that the parent and the child are jointly liable for the account and that both the parent and the child receive information about the activity of the account at their respective residences. A different dependent strategy can be created for a high school-age child living at home. The usage parameters can be selected so that the primary owner (e.g., a parent or guardian) is financially liable for the account and the account has a predetermined limit. The primary owner could set the limit on the account. A pre-defined card could also limit the types and locations of purchases made on the card.

The usage parameters can also be selected to create a dependent strategy for a dependent account held by the primary owner, such as a pre-defined card. The primary owner can use the key account and the dependent account to segregate expenses as discussed above. The usage parameters can be selected so that the primary owner is liable for the account and detailed information about the account is included on the group statement. As will be apparent to those skilled in the art, dependent strategies can also be adapted to address the needs of other situations.

Thus, the invention includes a method for creating a dependent strategy to customize a relationship between a dependent account and a group that comprises steps of: selecting a set of parameters from a group consisting of time limits, geographic limits, monetary limits, types of purchases made and use; defining values for the set of parameters to define group processing options; labeling the set of parameters and the values for the set of parameters as the dependent strategy; and associating the dependent strategy with the dependent account to customize the relationship between the decedent account and the group. The various usage parameters can be modified as necessary.

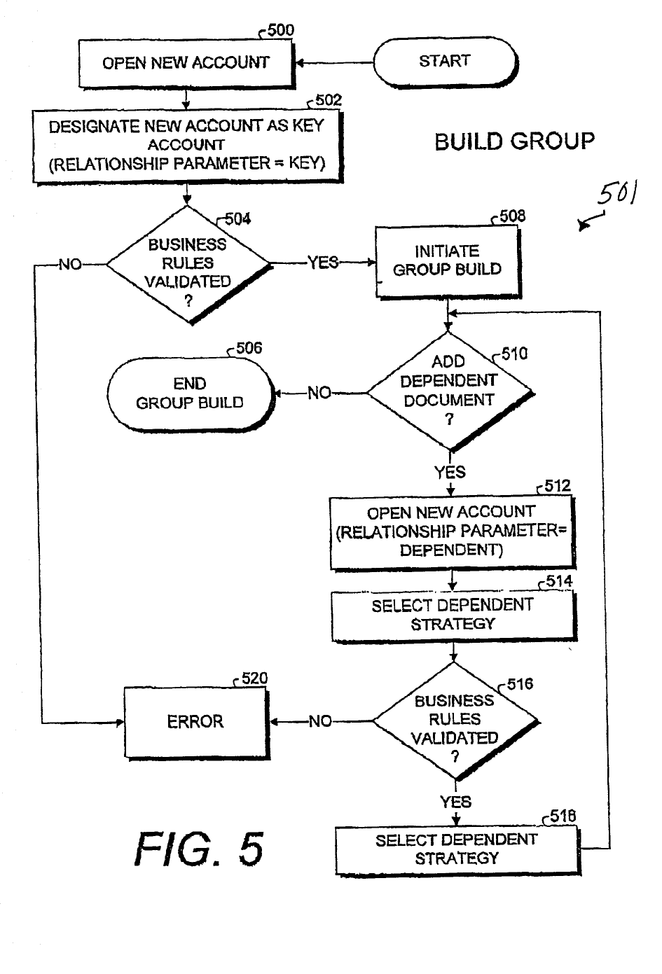

Various embodiments of the present invention further include systems and methods for creating groups such as those previously described. FIG. 5 is a flow diagram 501 that illustrates one embodiment for forming a group. Following flow diagram 501, a new account is opened (block 502). In some embodiments, the newly opened account is designated as the key account for the group that is being created (block 502). In addition, business rules are used to validate the opening and/or use of the new account as a key account (block 504). Where the business rules indicate that the new account is for some reason unacceptable, an error is generated (block 520).

Alternatively, where the business rules indicate that the account is acceptable, a build of the group is initiated (block 508). Building the group can include creation of group master data file 400 for the group and the various files associated therewith. It is also determined if additional dependent accounts are to be added (block 510). If not, the process is ended (block 506), otherwise, an additional new account is opened and defined as a dependent account within the group (block 512). A dependent strategy for the dependent account is also selected and/or defined by selecting various usage parameters and/or dependent strategies (block 514). In addition, the newly opened dependent account is subjected to the various business rules to determine if the account can be properly opened as a dependent account and./or if the account can be properly combined within the group and with the selected dependent strategy (block 516). If the newly created dependent account is acceptable, it is opened and the dependent strategy is associated therewith (block 518). The process is repeated until desired dependent accounts are included within the group (block 510).

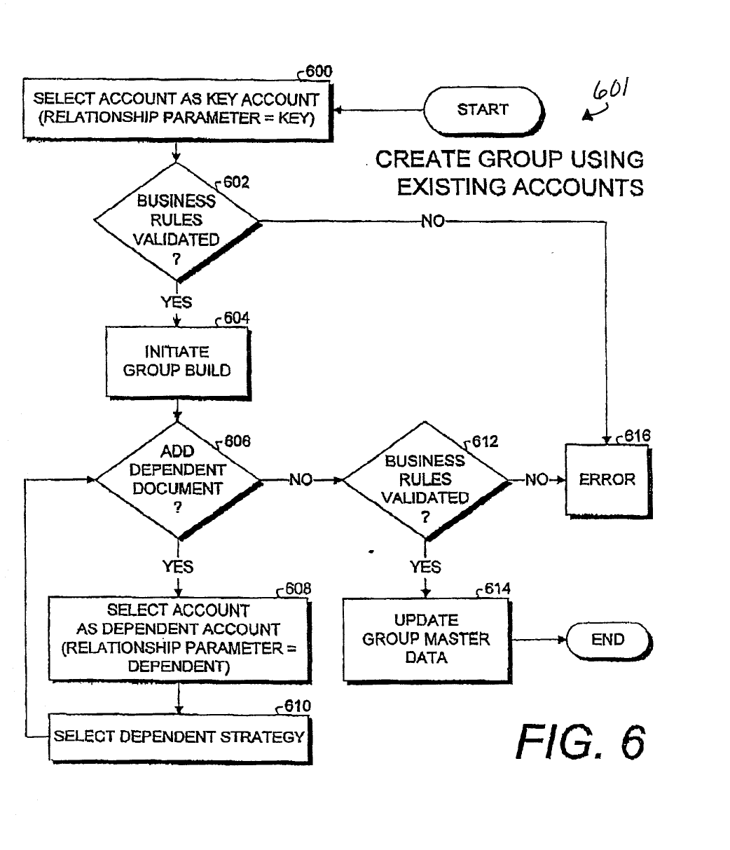

FIG. 6 is a flow diagram 601 illustrating an embodiment for creating an account group from one or more existing accounts. Following flow diagram 601, an existing account is selected as a key account for the group being created (block 600). In some embodiments, the selected account is analyzed using various business rules to validate the use of the selected account as a key account (block 602). Where additional accounts are to be added to the group, the accounts are selected (block 608) and one or more dependent strategies linking the selected account to the group are also selected (block 610). This process is repeated until the desired dependent accounts have each been selected.

Once the accounts have been selected (blocks 606, 608, 610), various business rules are applied to the selected accounts to assure that they can be properly combined within the group as it is being created (block 612). If one or more of the accounts, dependent strategies, other group usage parameters are unacceptable, an error is generated (block 616). Otherwise, group master data 400 for the created group is updated to include the various files discussed in relation to FIGS. 4 (block 614).

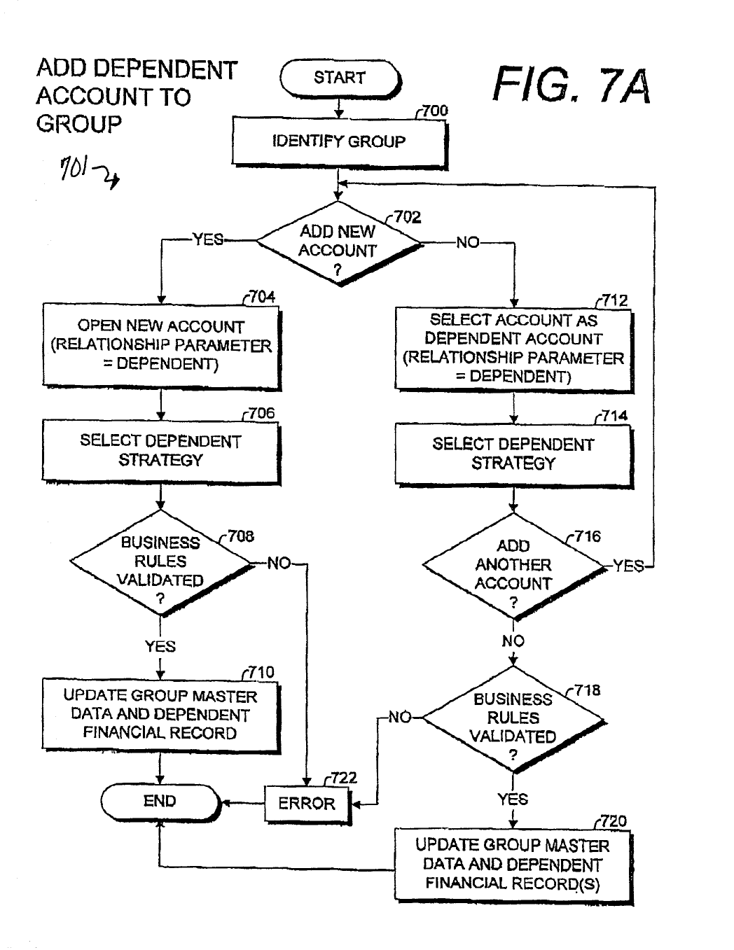

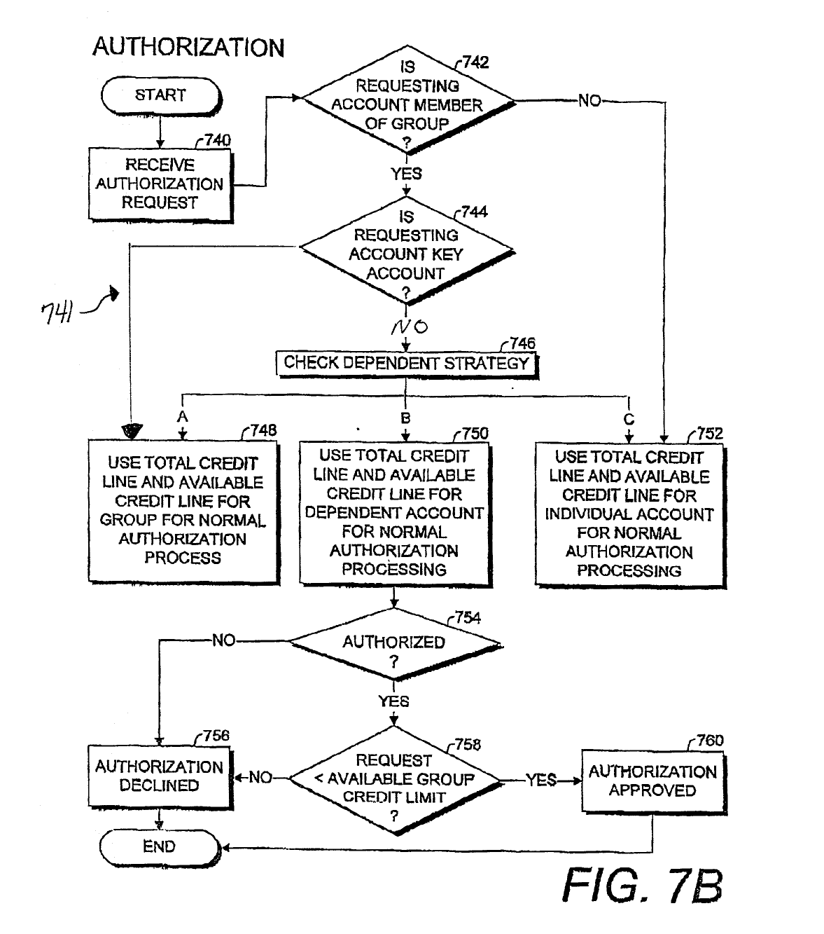

Once a group is created, additional dependent accounts can be added to and/or deleted from the group. Further, the designation of which account is the key account can be changed. FIG. 7A is a flow diagram 701 illustrating an embodiment of a method for adding a dependent account to an existing group. Following flow diagram 701, a group to which the dependent account will be added is selected (block 700). In some cases, a group is identified using the group identifier. A determination is made as to whether an existing account is to be added or whether a new account is to be added (block 702). Where a new account is to be added, then the a new account is opened and the relationship parameter for the account is set to dependent (block 704). Further, a dependent strategy for the new account is selected (block 706). This dependent strategy can include the limits and parameters associated with the pre-defined card, such as time limits, geographic limits, use limits and the like as discussed above. A determination is made as to whether the newly opened dependent account (block 704) satisfies various business rules or product usage criteria (block 708). If the dependent account satisfies the business rules and/or product usage criteria, group master data 400 is updated to reflect the newly added dependent account (block 710), otherwise, an error is generated (block 722).

Alternatively, if it is determined that an existing account is to be added to the group (block 702), then the existing account is selected (block 712). In addition to selecting the existing account, the relationship parameter for the selected account is set to indicate a dependent account. Further, one or more dependent strategies for the selected account are selected and/or defined (block 714). This process is continued until each desired dependent account is included in the group (block 716). The usage parameters for the dependent account are compared to the business rules and/or product usage criteria (block 718). If the usage parameters for the dependent account satisfy the business rules or product usage criteria, then the usage criteria are validated and group master data 400 is updated to reflect the account(s) newly added to the group (block 720). Alternatively, an error message is generated (block 722).

Although FIG. 7A indicates that group master data 400 is updated either after all accounts have been added, group master data 400 can be updated at other points in the process. For example, if multiple accounts are to be added to an existing group, group master data 400 can be updated after each individual account is added. Updating group master data 400 after the addition of each account can be used to support on-line processing, whereas updating group master data 400 after the addition of a number of dependent accounts can be used to support batch processing.

Once a group is created, it can be used to perform group processing. Such group processing can include, among other things, authorizing transactions, applying group payments, creating group statements, controlling cardholder communications, and administering reward programs for the accounts in the group. Information from both the key account and the dependent accounts can be used for group processing. Each dependent account has an associated dependent strategy that specifies group processing options for the dependent account. While each account in a group is subject to group processing for some functions, each of the individual accounts can be processed individually for various other functions.

In some cases, a dependent strategy for a dependent account, such as a pre-defined card, specifies authorization procedures and/or options associated with the card. Such procedures and/or options specifies the information that is used to authorize a transaction. In some embodiments of the present invention, several authorization options are available for a dependent account. One authorization option considers only the credit line and available credit of the group, while a second option considers only the credit line and available credit of the dependent account, and a third option considers the credit line and the available credit of both the group and the dependent account. Further, other procedures and/or options can be designed to consider time, location, use, and the like.

Depending upon the authorization procedure(s) and/or option(s) selected or defined, authorization processing uses the group credit line and the group available credit and/or the dependent credit line and the dependent available credit. The group credit line is a group parameter that typically is set when the group is created. The dependent credit line is a dependent account parameter that is set when the dependent account is opened. The group credit line and the dependent credit line can be modified. The group available credit can be calculated in real time using activity from the key account (if any) and any dependent accounts that share the group credit line. In some cases, a dependent account is considered to share the group credit line if payment for the dependent account is due from the primary owner of the group to which the dependent account is a member. In various embodiments, the group available credit is calculated by subtracting the current balances and any outstanding authorizations of the accounts that are associated with the group. Similarly, the dependent available credit is calculated by subtracting the current balance and any outstanding authorizations of the dependent account from the dependent credit line.

FIG. 7B is a flow diagram 741 that illustrates a method for performing authorizations in accordance with various embodiments of the present invention. The method of flow diagram 741 can be applied to any of the limits placed on a pre-defined card, and are not intended to be limited to the credit authorization specifically shown. Following flow diagram 741, an authorization request is received (block 740). In some cases, such an authorization request is received from a merchant presented with a credit card from a account holder. The authorization request includes a transaction amount and an account identifier, such as an account number. Using information associated with the authorization request, it is determined whether the requesting account is associated with one or more groups of accounts (block 742). If the requesting account is not a member of a group, then the credit line information associated with the particular requesting account is used to authorize processing (block 752). Such an approach can be similar to standard credit card processing where limits associated with an individual account are used for authorization purposes.

In some cases, such authorization processing can include several calculations that use the credit line and the available credit for the requesting account. For example, authorization may include comparing the amount and/or circumstances of the transaction to the available credit, to a percentage expansion of the credit line, or to past transactions for the account. Comparing the transaction to past transactions for the account may be used to detect possible fraudulent uses of a card and may result in the issuance of a referral code. As will be apparent to those skilled in the art, additional calculations can also be performed, especially in relation to a pre-defined card.

Where it is determined that a requesting account is a member of a group (block 742), it is next determined if the requesting account is a key account or a dependent account within the group (block 744). If the requesting account is a key account, authorization processing occurs using the group credit line and the group available credit (block 748).

Alternatively, where it is determined that the requesting account is a dependent account, the dependent strategy associated with the dependent account is checked to determine the authorization option that corresponds to the dependent account (block 746). As illustrated in flow diagram 741, three possible authorization options 748, 750, 752 are available. One skilled in the art will, however, recognize a myriad of other options and/or procedures that are possible in accordance with the present invention. As illustrated, either the total credit line for the group can be used (block 748), the total credit line for both the group and the dependent account may be used (block 750), or the total credit line and available credit line for the account as it would exist without association with the group may be used (block 752).

The option used for processing is defined by the check of dependent strategies (block 746). The difference between the authorization processing performed in relation to block 748 and that of block 752 is that group information is used in relation to block 748, and only dependent account information is used in relation to block 752.

Further, processing according to block 750 uses a hybrid of limits associated with both the dependent account and the group with which the dependent account is associated. Such hybrid processing can include a determination whether the processing performed in step 750 indicates that the authorization request is authorized. If the processing performed using the dependent account information indicates that the request is authorized, then the “Yes” branch is followed to step 758. In step 758, a determination is made as to whether the transaction amount specified in the authorization request exceeds the group available credit. If the amount does not exceed the group available credit, then the “Yes” branch is followed to step 760 and the authorization request is approved. If the processing performed in step 754 indicated that the authorization request is denied or if the comparison performed in step 758 indicates that the amount of the request exceeds the group available credit, then the “No” branch is followed to step 756 and the authorization request is declined.

Similar analysis can be applied in relation to other authorization limitations. For example, a time limit may be placed on authorizations such that transaction requests received in a particular time frame are not authorized. Other options and/or procedures can relate to the type of transaction being requested, and/or hybrids of the aforementioned approaches. Thus, for example, where a jewelry purchase is requested for an amount above a specified limit, it may be denied, while a purchase at a grocery store above the same limit may be authorized. As another example, a gasoline purchase at one time of day may be authorized, while the same gasoline purchase at another time of day is denied.

Payments can be made directly to the pre-defined card account or via the group payment method described above and in the incorporated references. Furthermore, statements and communications with or about the members of the group can be generated either directly for an account or for a group as described above and in the incorporated documents. Reward points can be credited directly to the pre-defined card account, or to a group as discussed above and in the incorporated documents. A pre-defined card can be added to a group according to the methods discussed above and in the incorporated documents.

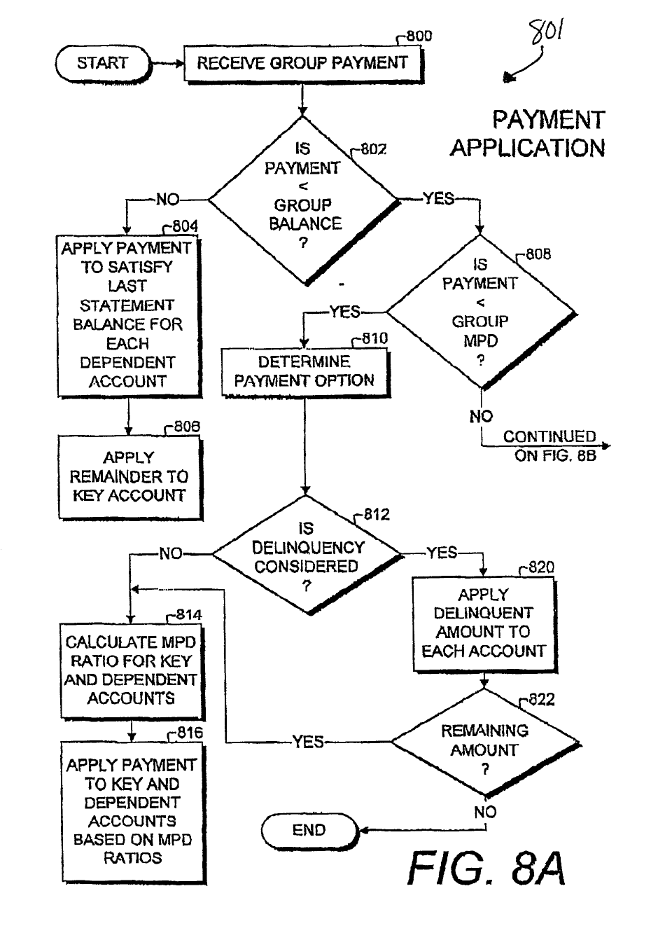

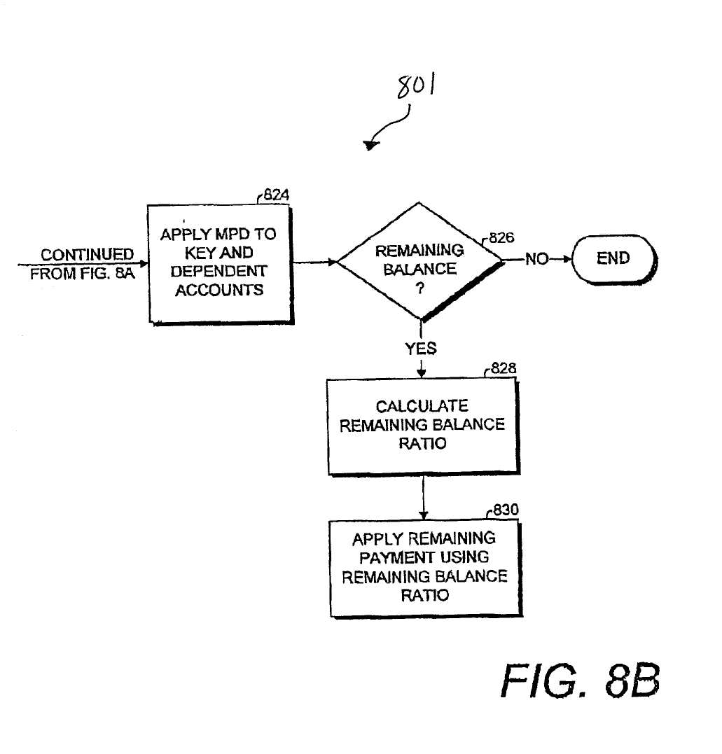

FIGS. 8-10 illustrate various examples of processing in relation to the aforementioned groups. More particularly, FIG. 8 include a flow diagram 801 illustrating the dispersion of received payments to accounts within a group. Following flow diagram 801, a payment is received that is to be applied to a group of accounts (block 800). It is determined if the received payment is less than the balance for the group as a whole (block 802). Where the received payment is greater than or equal to the amount due for the group, the payment is applied to satisfy the last statement balance for each account in the group including any key account and dependent accounts (block 804). Any payment received in excess of the amount due is applied to the key account, or where a key account does not exist, to one or more of the dependent accounts (block 806).

Where the amount of payment received is less than the balance for the group (block 802), then it is next determined if the payment received is less than the minimum payment due (“MPD”) (block 808). Where the payment received is less than the MPD for the group, the amount received is applied to the various accounts in proportion to the MPD for each of the individual accounts (blocks 810-816). In some cases, where one or more of the accounts within the group are delinquent, the payment can be preferentially applied to satisfy delinquency requirements (blocks 812, 820-822), with any remainder being applied to all accounts in proportion to the MPD for each of the accounts (block 814-816).

Where the payment received is greater than or equal to the MPD for the group, the amount received is first applied to satisfy the MPD for each of the accounts (block 824). Any remaining balance can then be applied to the various accounts (blocks 826-830). In some embodiments, such as that illustrated in flow diagram 801, the remainder is applied to each of the individual accounts in proportion to the remaining outstanding balance for each of the accounts.

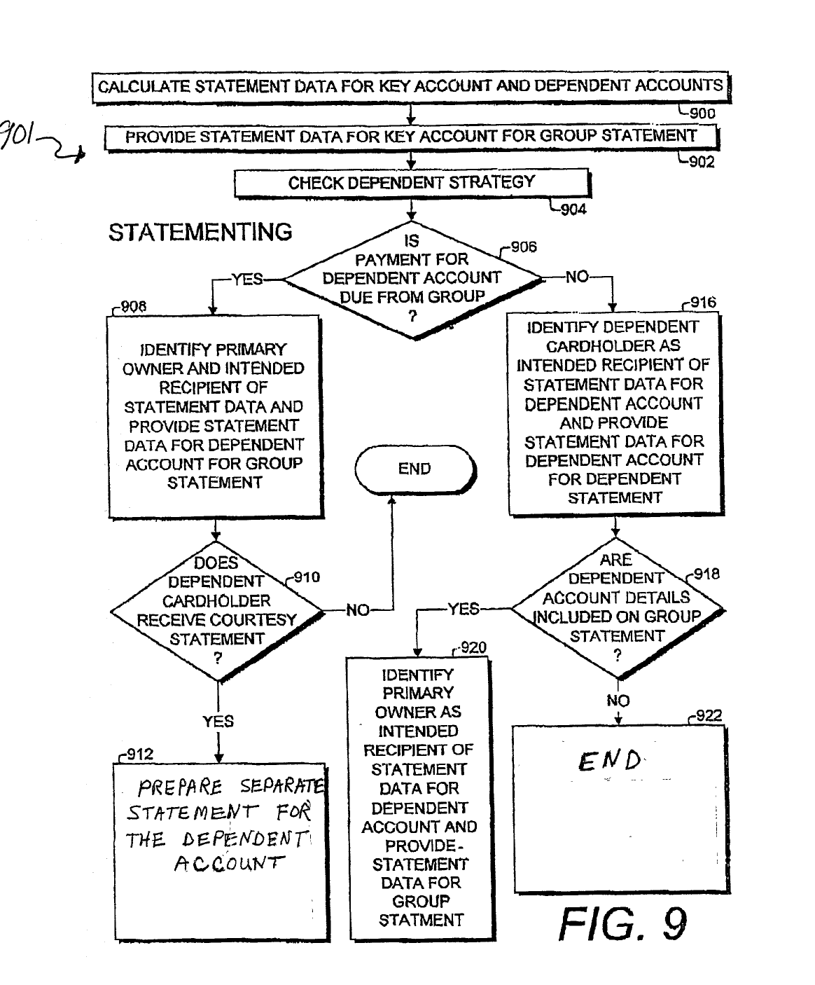

FIG. 9 is a flow diagram 901 illustrating statement preparation for a group of accounts. Following flow diagram 901, statement data for each account within the group is calculated (block 900). Statement data for any key account is provided for inclusion with a group statement (block 902). In addition, one or more dependent strategies are checked to determine if such strategies impact the statement generation process (block 904).

From analysis of the one or more dependent strategies associated with the group, it is determined if payment for a given dependent account is due from the group, or exclusively from the owner of the dependent account (block 906). Where payment is due from the group, the primary owner of the group is identified, as well as an intended recipient of the group statement (block 908). Further, the statement information associated with the dependent account is provided for inclusion with the group statement (block 908). In addition, it is determined if the holder of the dependent account receives a courtesy statement reflecting activity on the dependent account (block 910). If a courtesy statement is to be provided to the holder of the dependent account, a separate statement is prepared reflecting the activity of the dependent account (block 912).

Where payment is not due from the group (block 906), the holder of the dependent account is identified as the intended recipient of any prepared statement (block 916). The information associated with the dependent account is also provided for inclusion on the statement to the holder of the dependent account (block 916). It is further determined if information associated with the dependent account is to be provided as part of the group statement (block 918). Where the information is to be included, the primary owner of the group of accounts is also identified as a recipient of the information (block 920). Alternatively, where the group statement is not to include information on the dependent account, the information is not included with the group statement (block 922).

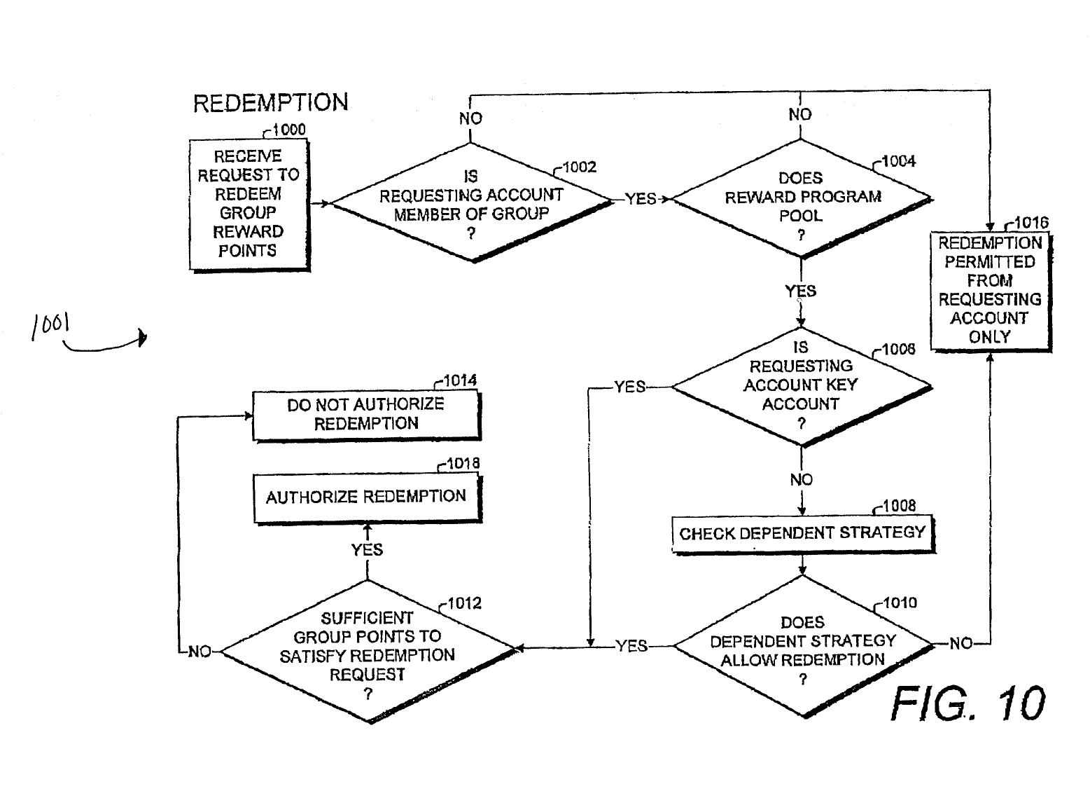

FIG. 10 is a flow diagram 1001 illustrating the pooling and redemption of reward points accumulated via the various accounts within a group of accounts. Following flow diagram 1001, a request to redeem a given type of reward points is received (block 1000). Based on the request, it is determined if the requestor is a member of the group (block 1002). If the requestor is not a known member of the group, an error message is provided indicating that only group members may request redemptions (block 1016).

Where the requestor is a member of the group (block 1002), it is determined if the reward points can be pooled between the various accounts (block 1004). If it is determined that the reward points cannot be pooled, an error message is displayed (block 1016). In such a case, the reward points are redeemed by the owner of an individual account, rather than on a group basis.

Alternatively, where the reward points can be pooled (block 1004), it is determined if the requestor is the owner of a key account within the group, or an owner of a dependent account within the group (block 1006). If the requestor is not a key account owner, the dependent strategy associated with the dependent account(s) that the requestor is associated with is accessed (block 1008). Through accessing the dependent strategy, it is determined whether the requestor is authorized to access pooled reward points within the group (block 1010). If the requestor is not authorized, then an error message is provided (block 1016).

Where the requestor is either an authorized dependent account owner (blocks 1006-1010), or a key account owner (block 1006), it is determined if sufficient reward points have been accrued to satisfy the redemption request (block 1012). The redemption is either authorized (block 1018) where sufficient points have accrued, or denied (block 1014) where insufficient points have accrued.

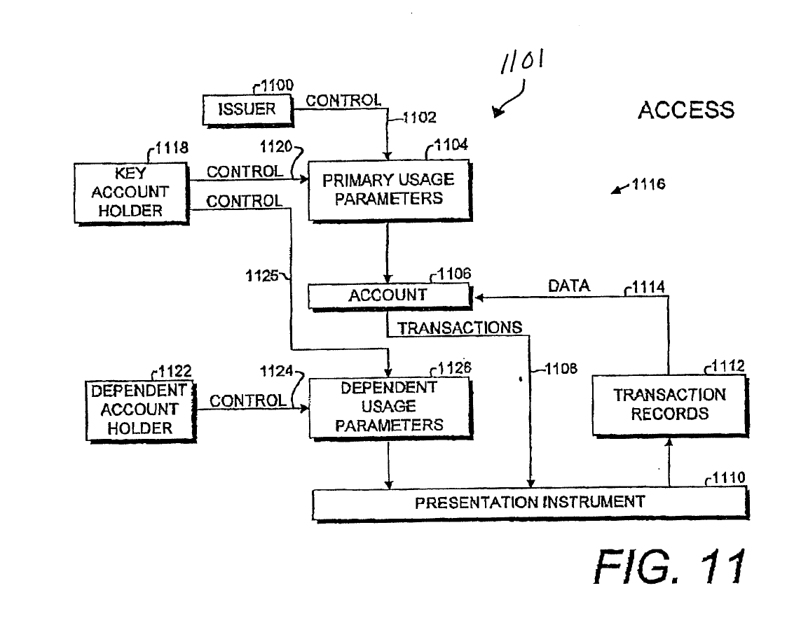

FIG. 11 is a block diagram 1101 illustrating an embodiment of a system for allowing usage parameter modifications in accordance with the present invention. More particularly, block diagram 1101 illustrates usage parameter modifications effectuated by one or more of a key account holder 1118, a dependent account holder 1122, and/or an issuer 1100. As illustrated, an issuer 1100 can modify primary usage parameters 1104 associated with the group by transferring one or more control commands 1102. In some embodiments, control commands 1102 are provided by issuer 1100 at the time an account 1106 is created. At the time account 1106 is created, primary usage parameters 1104 can be a default set of usage parameters. Primary usage parameters 1104 can include, but are not limited to, some or all of the product usage parameters discussed above. Primary usage parameters 1104 are associated with an account 1106. Transactions 1108 involving account 1106 are implemented with one or more presentation instruments 1110, which result in transaction records 1112 which are applied to account 1106 as data 1114. Account 1106 and presentation instrument 1110 associated therewith generally comprise a product offered by issuer 1100.

Key account holder 1118 can modify primary usage parameters 1104 by transferring one or more control commands 1120. Such modifications can be effectuated at the time account 1106 is opened, or at some time after account 1106 is opened. In some embodiments, modifications of account 1106 are accomplished in using an interactive, real-time tool for providing such modifications. In addition, key account holder 1118 can modify dependent usage parameters associated with one or more accounts within the group.

A dependent account holder 1122 can exercise control at 1124 over dependent usage parameters 1126. The dependent usage parameters 1126 can overlap the primary usage parameters 1104 to any desired extent. Thus, the methodology of the present invention can accommodate dependent account holders 1122 being given any desired degree of control over the usage parameters associated with a particular account, with such degree of control being subject to continuos change and updating to accommodate the needs of the account holders 1118 and 1122. For example, over a period of time a dependent account holder 1122 can be given a greater degree of control and access over the usage parameters by the key account holder 1118. The key account holder 1118, may be, but is not required to be, the primary owner of the account 1106.

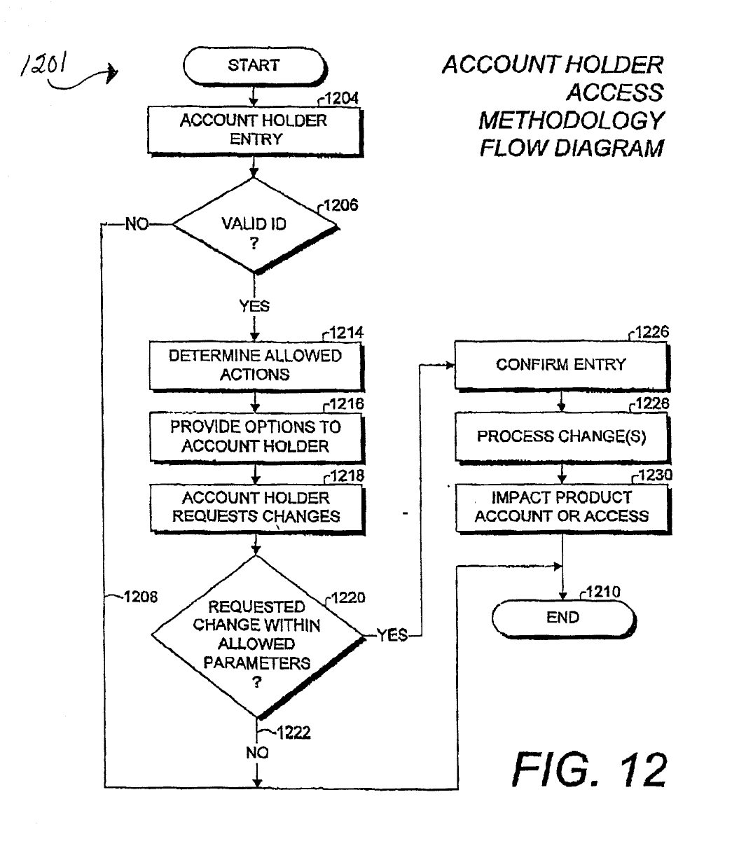

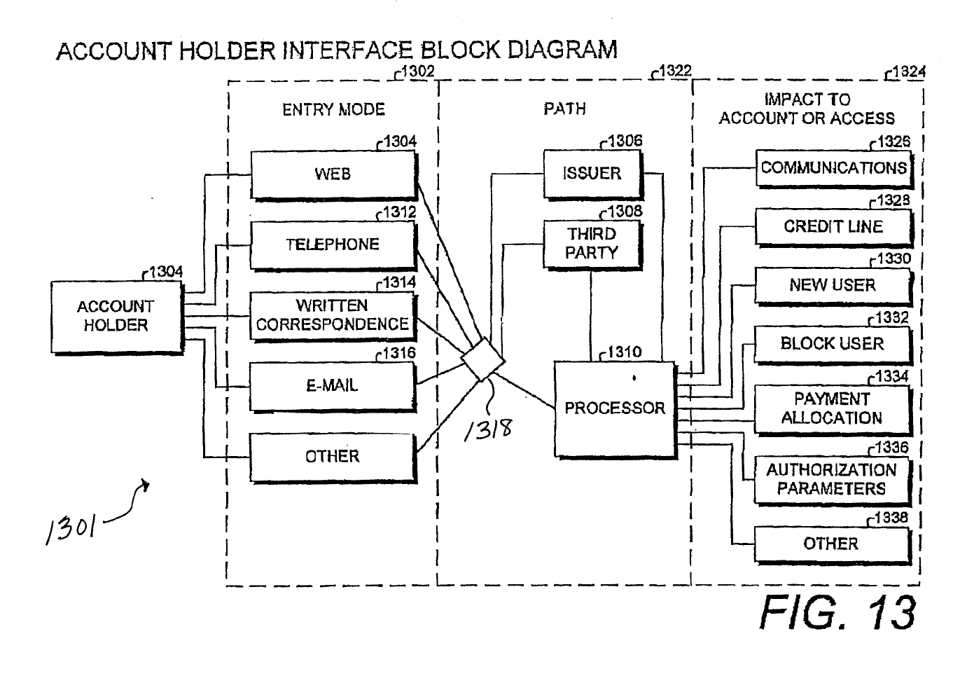

FIG. 12 is a flow diagram 1201 of a method in accordance with an embodiment of the present invention for allowing access to usage parameters to one or more owners associated with a group of accounts. Following flow diagram 1201, an account holder is identified to the system (block 1204). In some embodiments, this can include interacting with a computerized system for modifying usage parameters. Such interaction can thus be accomplished using a telephone system with a voice recognition system, the Internet or other computer network where information is transferred from one computer to another, or other like system for passing information between an account owner and an entity responsible for maintaining and/or processing one or more accounts within the group. Systems for facilitating such communication are described in greater detail in with reference to FIG. 13 below.

In some embodiments, an account holder provides authorization information that is used to determine if the account holder is authorized to modify one or more parameters associated with the group (block 1206). In some cases, each account holder within a group are assigned a user identification and a password that allows access commensurate with rights assigned within the group to the particular account holder. Such rights can be defined as the limits of a key account, a set of accounts within the group, and/or limits defined in relation to dependent strategies within the group. Where the provided account holder information does not identify and/or verify an authorized account holder, the process of modifying usage parameters is terminated (block 1210).

Alternatively, where an account holder is identified and verified (block 1206), it is determined which actions the particular account holder is authorized to effectuate within the group (block 1214). These actions can be derived from various dependent strategies associated with the group. For example, where the identified account holder is an owner of a dependent account, the actions may include requesting a courtesy statement associated with the dependent account, requesting historical information associated with the dependent account, setting access parameters associated with the dependent account, disassociating the dependent account from the group, reducing any credit line associated with the dependent account, changing a name on the dependent account where a name change has occurred, assuming additional liability for the dependent account, closing the dependent account, and the like. Further, various security parameters can be changed in relation to the dependent account, such as, not approving any purchases outside of a geographic limit, or of a particular type. In various embodiments, authorization to make various usage parameter requests is predefined and imbedded within the various dependent strategies associated with the group. Thus, approval is not sought from an issuer make the various modifications, but rather from the group. The issuer thus allows options predefined and/or later provided in association with a group.

In some cases such options can be subject to various limits associated with the group. Thus, for example, modifying the credit line of a dependent account can be limited to the total or a portion of the credit line associated with a key account. As another example, modifying the credit line of a dependent account can be limited to an aggregate of credit lines of two or more accounts within a group. Such modifications to a dependent account can be further limited through dependent strategies provided in a group. For example, a dependent strategy may limit the use of a dependent account to a particular geographic area, or to the purchase of certain goods, or to a total allowed credit line. Thus, modification to the usage parameters associated with the dependent account can be subject to limits defined in association with one or more dependent strategies.

As just one example, a key account holder may be a parent that assumes liability for a child's purchases on a dependent account. In such a case, a dependent strategy can be defined where the parent allows unfettered discretion in the use and access to the dependent account up to the limits of the key account. In such a case, the dependent account holder can modify the usage parameters to customize the function of the dependent account up to the limits of the key account. Thus, a credit line of the dependent account can be modified by the dependent account holder to any level below that of the key account, without requesting permission from an issuer of either the key account or the dependent account. This is contrary to known approaches where such a modification requires making a request to the issuer, and subsequently receiving authorization from the issuer. Rather, the authorization can be predefined and implicitly maintained within one or more dependent strategies associated with the group.

In other cases, the identified and verified account holder is the primary owner of the group and/or a key account holder. In such a case, the rights to modify usage parameters can be superior to that of a dependent account holder. For example, a key account holder, or other superior account holder may have rights to change not only the account to which they are the holder, but also other accounts within the group. A member of the group with such superior rights can, for example, freeze the use of one or more dependent accounts within the group, lower credit lines associated with the one or more dependent accounts, modify and/or impose limits on the types of goods that can be purchased using the dependent accounts, modify security measures implemented with respect to the dependent accounts, and the like.

Thus, in some embodiments, a parent may be the primary owner of a group where a child is a holder of a dependent account within the group. In such a case, the parent can modify the usage parameters associated with the child's dependent account. Such modifications can be effectuated without requesting permission from an issuer of the child's account, but rather based on a predefined permission set formed as a composite of the parent's account limits and/or various dependent strategies associated with the group. In some cases, the parent can make these changes through interaction with an automated system and without interacting with a person. This can avoid the anxiety that some feel in dealing with a human operator where the modification is occurring because of some level of distrust that the parent has for the child.

Thus, in various embodiments of the present invention, the system analyzes various limits associated with a key account and/or other accounts within a group, and various dependent strategies associated with the group. From this analysis, a variety of available actions that can be effectuated are determined (block 1214), and one or more of the determined actions are presented to the verified account holder for their selection (block 1216). Presentment of the selections is further described below with respect to FIG. 13.

The account holder can then select from one or more of the presented actions (block 1218). In some cases, the account holder can provide additional information and/or modifications to the presented selections. In such cases, the presented selections are only general categories and the additional information provided by the account holder specify the characteristics of the general selection. The specific request including the general category augmented with the specific requests is checked to assure that it is allowable using an approach similar to that described in relation to block 1214 (block 1220).

Where the request is allowable (block 1220), the receipt of the request is confirmed to the account holder (block 1226), the effected usage parameters are changed (block 1228), and the account(s) begin to be affected by the change (block 1230). In some cases, the changes can immediately effect the account, while in other cases, the changes can have a delayed affect.

FIG. 13 is a block diagram 1301 illustrating various methods for interfacing one or more account holders 1304 such that usage parameters can be modified. Block diagram 1301 includes a column depicting a variety of entry modes 1302 whereby account holder 1304 can access usage parameters associated with the accounts within a group. More particularly, entry modes 1302 include a website 1304 accessible via the Internet or some other computer network, a telephone 1312, written correspondence 1314, email 1316, and the like.

Various paths 1322 of communication between account holder 1304 and usage parameters associated with an account include a communication network 1318 that provides access to an issuer 1306 and/or a third party 1308. Communication network 1318 can include a variety of communication mechanisms including email transport, Internet Protocol transport, regular and express mail transport, voice transport, and the like. Thus, communication network 1318 can include a variety of different communication networks combined to create a composite network. For example, communication network can include a telephone network, a regular mail system, and the Internet. Either or both of issuer 1306 and third party 1308 process one or more requests received via entry modes 1302 and provide output from the processed requests to a processor 1310. Alternatively, requests from one or more of entry modes 1302 can be transmitted across communication network 1318 directly to processor 1310. Processor 1310 can be any microprocessor based device capable of receiving and processing one or more requests from account holder 1304.

In one embodiment, all requests received by either written correspondence 1314 or email 1316 are sent to issuer 1306, that in turn enters the request into an electronic format and provides the processed request to processor 1310. In the embodiment, requests input via telephone 1312 are directed to third party 1308 that can be a request processing group contractually affiliated with issuer 1306. Third party 1308 maintains an automatic voice response system that formats requests received via telephone 1312 and forwards the requests to processor 1310. Further, requests from website 1304 are transferred across communication network 1318 to processor 1310. In some cases, portions of communication network 1318, and processor 1310 are provided and maintained by issuer 1306.

Within the financial transaction processing business community, various functions can be allocated to different product and service providers, including those depicted in paths 1322. For example, third party 1308 can provide a wide range of products and/or services in connection with the financial transaction products issued by issuer 1306. Financial transaction processing is another significant segment of the industry, which utilizes processors, such as processor 1310 for performing the data processing and related functions associated with financial transactions by account holders.

Various usage parameters 1324 that can be modified include, but are not limited to communications 1326 associated with an account, a credit line 1328, adding and/or deleting members (e.g. dependent accounts as illustrated in FIG. 7A) from a group 1330, blocking access by one or more group members to various capabilities of the group 1332, defining payment allocations to various accounts within the group 1334, and transaction authorization parameters 1336 associated with the group and/or individual accounts or aspects of the group. Based on this disclosure, one of ordinary skill in the art will recognize a variety of other usage parameters that can be modified in relation to a group, or an individual account.

Various embodiments of the present invention include a single account with usage parameters, and two or more account holders associated therewith. Each of the two or more account holders can be enabled to use the account, and to access and modify the usage parameters associated with the account. Further, differing levels of access can be provided to each of the account holders. Thus, a single account can be accessed by multiple account holders, where access by each of the multiple account holders is individually limited by usage parameters.

As just one example of the preceding embodiment, three account holders may be associated with a particular account including, a parent, a child, and a nanny. Each of the account holders can have a credit card that allows access to the account and identification of which account holder is using the account. Further, such access to the account by each of the account holders can be limited by usage parameters associated with the account, and in some cases specific to a particular account holder. As previously discussed, these usage parameters can indicate credit limits, security features, and the like.

Thus, in the example, the usage parameters may limit the nanny to purchasing gasoline and groceries with the credit card, while the child may purchase anything under a particular amount within the hours of seven A.M. and eight P.M. The parent may be the only account holder authorized to modify all of the usage parameters, while both the nanny and the child may be authorized to modify some subset of the usage parameters. For example, the nanny may be enabled to modify usage parameters associated with security, thereby enabling the nanny to disable and re-enable use of the card by the nanny. Based on the disclosure provided herein, one of ordinary skill in the art will recognize various other ways that multiple users accessing a single account can be limited through the use and/or modification of usage parameters associated with the account.

### CONCLUSION

The invention has now been described in detail for purposes of clarity and understanding. However, it will be appreciated that certain changes and modifications may be practiced within the scope of the appended claims. For example, some embodiments of the present invention are applicable to groups of accounts, while other embodiments are applicable to either or both of individual account and groups of accounts. Further, while various of the embodiments described herein refer to account groups that include a key account associated with a group owner along with one or more dependent accounts, such a group structure is not required within the scope of the invention. Rather, a group of accounts can include two or more group member accounts, and a group owner. Such group member accounts are not necessarily related in a key/dependent relationship, and the group owner can be an owner of one or more of the group member accounts, or in some cases, merely associated with the group and not an owner of any group member account. Accordingly, it should be recognized that many other systems, functions, methods, and combinations thereof are possible in accordance with the present invention. Thus, although the invention is described with reference to specific embodiments and figures thereof, the embodiments and figures are merely illustrative, and not limiting of the invention. Rather, the scope of the invention is to be determined solely by the appended claims.

What is claimed is:

1. A method for accessing one or more usage parameters associated with a financial transaction account, the method comprising:
providing an account group, wherein the account group includes at least one group member account, and wherein the group member account is associated with at least one usage parameter;
receiving a request to modify the at least one usage parameter; and
modifying the at least one usage parameter.

2. The method of claim 1, wherein the at least one usage parameter at least partially defines a relationship between the group member account and the account group.

3. The method of claim 1, wherein the account group further includes a group owner, the method further comprising:
authorizing an account holder associated with the account group, wherein the account holder is identified as the group owner.

4. The method of claim 3, wherein the at least one usage parameter is a first usage parameter, the method further comprising:
presenting a second usage parameter to the key account holder, wherein the request to modify the at least one usage parameter includes an indication of the second usage parameter.

5. The method of claim 1, wherein the at least one usage parameter is a first usage parameter, the method further comprising:
authorizing an account holder associated with the account group, wherein the account holder is identified as the group member account holder; and
presenting a second usage parameter to the group member account holder, wherein the request to modify the at least one usage parameter includes an indication of the second usage parameter.

6. The method of claim 5, the method further comprising:
analyzing a dependent strategy associated with the group member account, wherein presenting the second usage parameter is based at least in part on the analysis of the dependent strategy.

7. The method of claim 5, the method further comprising:
analyzing a dependent strategy associated with the group member account to determine if the second usage parameter is allowable.

8. The method of claim 1, wherein the account group further includes a group owner, and wherein the at least one usage parameter is a first usage parameter, the method further comprising:
authorizing an account holder associated with the account group, wherein the account holder is identified as the group member account holder;
presenting a second usage parameter to the group member account holder, wherein the request to modify the at least one usage parameter includes an indication of the second usage parameter; and
requesting authority to implement the request to modify the usage parameter from the group owner.

9. The method of claim 1, wherein the receiving a request to modify the at least one usage parameter is done via an automatic voice response system.

10. The method of claim 1, wherein the receiving a request to modify the at least one usage parameter is done via the Internet.

11. The method of claim 1, wherein the modifying the at least one usage parameter is done automatically.

12. The method of claim 1, wherein the at least one usage parameter is selected from a group consisting of: a parameter related to liability for the group member account, a parameter related to a credit limit of the group member account, a parameter related to notification of activity associated with the group member account, a parameter related to linking the group member account to the account group, and a parameter related to security associated with the group member account.

13. A method for modifying usage parameters associated with financial accounts, the method comprising:
providing a dependent strategy from an issuer, wherein the dependent strategy includes a usage parameter that at least in part defines an account;
receiving a request to modify the usage parameter from an account holder; and
modifying the usage parameter.

14. The method of claim 13, wherein the usage parameter is selected from a group consisting of: a parameter related to liability for the account, a parameter related to a credit limit of the account, a parameter related to notification of activity associated with the account, a parameter related to linking the account to a group of accounts, and a parameter related to security associated with the account.

15. The method of claim 13, wherein the receiving a request to modify the usage parameter is done via one of the following: an automatic voice response system, and the Internet.

16. The method of claim 13, the method further comprising:
associating the account with a group of accounts.

17. The method of claim 16, wherein the group of accounts comprises a group owner, the method further comprising:
authorizing the group owner.

18. The method of claim 17, wherein the usage parameter is a first usage parameter, the method further comprising:
presenting a second usage parameter to the group owner, wherein the request to modify the usage parameter includes an indication of the second usage parameter.

19. The method of claim 17, wherein the account is a group member account, the method further comprising:
authorizing an account holder associated with the group of accounts, wherein the account holder is identified as the group member account holder; and
presenting a second usage parameter to the group member account holder, wherein the request to modify the at least one usage parameter includes an indication of the second usage parameter.

20. A method for modifying one or more usage parameters associated with financial accounts, the method comprising:
issuing a credit card to an account holder, wherein at least a first usage parameter is associated with the credit card, and wherein the first usage parameter is selected from a group consisting of: a parameter related to liability for the credit card, a parameter related to a credit limit of the credit card, a parameter related to notification of activity associated with the credit card, a parameter related to linking the credit card to the group of accounts, and a parameter related to security associated with the credit card;
presenting a second usage parameter to an account holder via the Internet;
receiving a request to modify the first usage parameter, wherein the request includes the second usage parameter; and
modifying the first usage parameter to include the second usage parameter.
